(19) United States
(12) Patent Application Publication
(10) Pub. No.: US 2025/0350883 A1
(43) Pub. Date: Nov. 13, 2025

(54) ADJUSTING MICROPHONE POSITIONS

(71) Applicant: Hewlett-Packard Development Company, L.P., Spring, TX (US)

(72) Inventors: Chung-Chun Chen, Taipei City (TW); Chih-Ming Huang, Taipei City (TW); Ming-Shien Tsai, Taipei City (TW)

(73) Assignee: Hewlett-Packard Development Company, L.P., Spring, TX (US)

(21) Appl. No.: 18/872,494

(22) PCT Filed: Jul. 19, 2022
(86) PCT No.: PCT/US2022/037538

§ 371 Date: Dec. 6, 2024

(51) Int. Cl. H04R 1/34; H04R 1/08; H04R 29/00

(52) U.S. Cl. CPC H04R 1/342; H04R 1/083; H04R 29/004; H04R 2499/15

(57) ABSTRACT

Examples described herein relate to systems and devices consistent with the disclosure. For instance, the computing device comprises a microphone, an antenna to receive signals providing positioning information, and a non-transitory machine-readable medium storing instructions executable by a processing resource to receive positioning information from the antenna, calculate a position of a receiver of the microphone based on the positioning information, and adjust the position of the receiver of the microphone towards a direction determined by the calculated positioning information.

### BACKGROUND

Computing systems, such as notebooks, desktops etc., can communicate with other electronic devices during telecommunication session. The computing system may activate different applications to access a telecommunications session. Components, such as microphones, of the computing systems can be used during the telecommunication session. The microphone may be used to communicate with other electronic devices. Electronic devices coupled to the computing system may transmit information to and from the computing system at various time.

### BRIEF DESCRIPTION OF THE DRAWINGS

FIG. 1 illustrates an example of a computing device.

FIG. 2 illustrates an example processing resource and memory resource suitable for use within a system.

FIG. 3 illustrates an example of a system including a computing device and a positioning device.

FIG. 4 illustrates an example diagram of a non-transitory machine-readable medium suitable for use within a system.

FIG. 5 illustrates an example of a system including a computing device and a positioning device.

### DETAILED DESCRIPTION

Systems described herein can be used to detect sound waves from a user during a telecommunication session. The system can include a microphone to detect the sound waves from the user. That is, as the user speaks or otherwise makes noise, the microphone of the system can detect the voice and/or noise made by the user during the telecommunications session. Moreover, systems can send the sound waves from the user to an audio sensor during the telecommunication session. Sending the sound waves to audio sensors can allow participants to communicate with the user during the telecommunication session.

However, as a user moves around the microphone, the system may have trouble detecting the voice of the user and/or the noises produced by the user. For example, the microphone may not be able to clearly discern the words of the user because the user may be too far away or out of range. Hence, the system may not be able to adequately reproduce the sound for the participants in the telecommunication session. This can make it difficult for the user and the participants to properly communicate when holding a telecommunication session.

As such, systems, as described herein, include computing devices that are able to enhance the sound waves provided by a user to a microphone when the microphone is in use. For example, the computing device can include a processing resource to adjust the receiver of the microphone while the microphone is being used. For instance, the processing resource can receive positioning information informing the computing device of the location of a user in possession of a positioning device. The processor can then adjust the position of the receiver of the microphone towards a direction determined by positioning information to enhance the sound waves provided by the user.

Notably, such systems improve the quality of the audio provided by a user, as compared to systems that include a microphone receiver that does not adjust towards the sound provided by a user. That is, directing the receiver towards the user in possession of the positioning device can enhance the quality of the voice and/or noise provided by the user ensuring that participants in a telecommunication session clearly hear the user. Hence, the computing device will be able to adequately reproduce the sound for the participants in the telecommunication session, allowing proper communication during the telecommunication session.

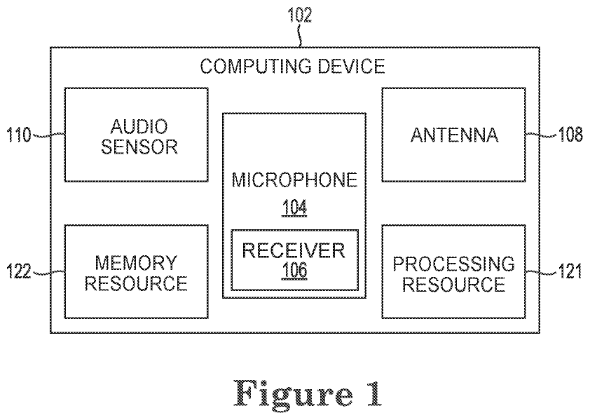

FIG. 1 illustrates an example of a computing device 102. Computing devices can include a variety of devices, such as, a desktop computer, a portable computer, a tablet, a mobile phone, internet of things (IoT) device, a phablet, etc. In some examples, the computing device 102 can be a notebook computer or a laptop computer. The computing device 102 can initiate a variety of applications that utilizes different components of the computing device 102. For example, the computing device 102 can initiate an audio/video telecommunication application that uses the microphone 104 component of the computing device 102. When the computing device 102 initiates an application, the microphone 104 can activate to receive sound waves from a user in the vicinity of the computing device 102. As used herein, an “application” refers to a collection of instructions and data that tell a computing related device how to execute specific tasks. As used herein, “microphone” refers to an instrument for converting sound waves into electrical energy variations which can be amplified, transmitted, and/or recorded.

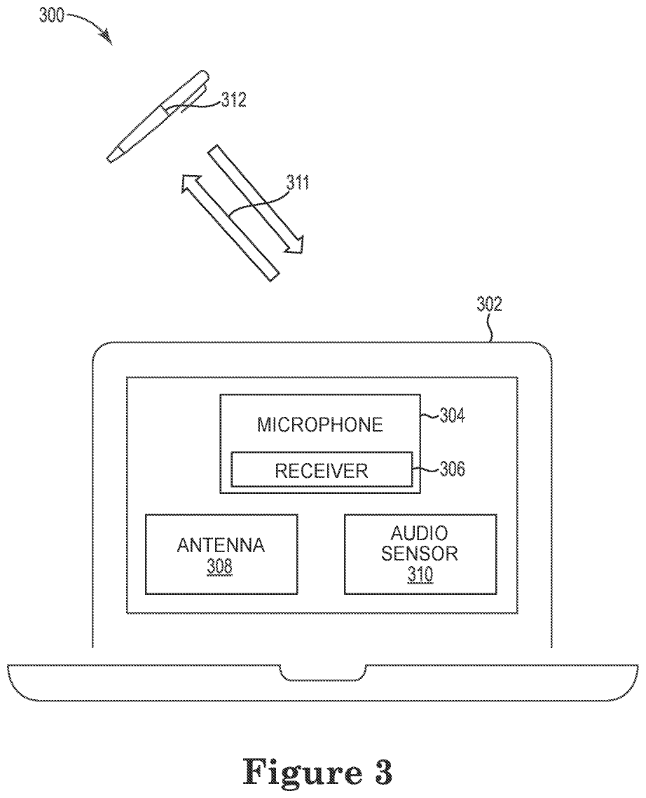

In some examples, the computing device 102 can be communicatively coupled to a positioning device (e.g., positioning device 312 of FIG. 3) to determine the direction of sound waves provided by a user in possession of the positioning device. As used herein, “communicatively coupled” refers to various wired and/or wireless connections between devices such that data and/or signals may be transferred in various directions between the devices. The computing device 102 determines the direction of the sound waves based on a signal received from the positioning device. For example, the computing device 102 can include an antenna 108 and a processing resource 121. The antenna 108 of the computing device 102 receives signals including positioning information from a positioning device and sends the positioning information to the processing resource 121. The processing resource 121 can calculate the positioning information to determine the location of the positioning device when executing instructions stored on a memory resource 122.

In some examples, the antenna 108 can receive signals from the positioning device each time the location of the positioning device changes. However, this disclosure is not so limited. For instance, the antenna 108 can receive signals related to positioning information at set intervals. For example, the set intervals can range from 500 milliseconds (ms) to about 2 seconds(s). All individual values and subranges from 500 ms to 2 s are included and disclosed herein. For example the intervals can range from a lower limit of 1.249 s, 1.2 s, 1.15 s, 1.1 s, 1.05 s, 1 s, 950 ms, 900 ms, 850 ms, 800 ms, 750 ms, 700 ms, 650 ms, 600 ms, 575 ms, 550 ms, or 525 ms, to an upper limit of 2 s, 1.9 s, 1.8 s, 1.7 s, 1.6 s, 1.5 s, 1.45 s, 1.4 s, 1.35 s, 1.3 s, or 1.251 s. In some examples, the antenna 108 can receive signals related to positioning information substantially continuously. As used herein, the term “substantially” intends that the characteristic does not have to be absolute but is close enough so as to achieve the characteristic. For example, “substantially continuous” is not limited to absolute continuous.

In some examples, the processing resource 121 uses the positioning information received from the antenna 108 to calculate the location of the positioning device each time the computing device 102 receives a signal including positioning information. For instance, as described herein, the processing resource can use Time-of-Flight (ToF), Time-Difference-of-Flight (TDoF), Angle-of-Arrival (AoA), Angle-of-Departure (AoD), or a combination thereof to calculate the location of the positioning device.

The processing resource 121 uses the calculated location of the positioning device to determine which direction to adjust the receiver 106 of the microphone. In some examples, the processing resource 121 will cause the receiver 106 to adjust based on the calculated location of the positioning device. That is, the receiver 106 of the microphone 104 changes positions within the computing device 102 to improve the detection of sound waves directed to the microphone 104 from a user in possession of the positioning device, as compared to a receiver that does not change positions. For instance, as described herein, the position of the receiver 106 is directed towards the positioning device and the user to improve the detection of the sound waves.

The position of the receiver 106 will turn (e.g., adjust) towards the positioning device to clearly detect the sound waves coming from that direction. For example, a user may use the microphone 104 when a communication application is initiated in the computing device 102. The user, in possession of the positioning device, may walk around while using the stationary microphone 104 of the computing device 102 which can change the quality of the sound waves received by the microphone 104. As such, the receiver 106 of the microphone 104 adjusts towards the positioning device and the user allowing the microphone 104 to maintain the quality of the sound waves received. That is, as the user moves around an area, the receiver 106 will adjust towards and face the positioning device to ensure the sound waves from a user in possession of the positioning device are directed at the receiver 106.

In some examples, the processing resource 121 can increase the volume of the detected sound waves, based on the location of the positioning device, to improve the quality of the sound waves received, as compared to computing devices that do not increase the volume of detected sound waves based on the location of the sound waves received. For instance, the processing resource 121 can determine if the audio from the sound waves is audible based on the distance between the positioning device and the microphone 104 in the computing device 102. If the processing resource 121 determines that the audio from the sound waves is not audible, then the processing resource 121 will increase the volume of the sound waves before the sound waves are sent to the audio sensor 110. As used herein, “audio sensor” refers to a device that converts electrical audio signals, sound waves, etc. into a corresponding sound.

In some examples, the audio sensor 110 can cause the sound waves to be heard from the computing device 102. The audio sensor 110 will play the sound waves at the volume specified by the processing resource 121. In addition, the audio sensor 110 can separately increase or decrease the volume of the sound waves received at the specified volume. In some examples, the audio sensor 110 can be located on the computing device 102. However, this disclosure is not so limited. For example, the processing resource 121 can send the sound waves to an audio sensor 110 external to the computing device 102. For instance, the audio sensor 110 can be a stand-alone audio sensor device not implemented in another device or the audio sensor 110 can be located on a second computing device.

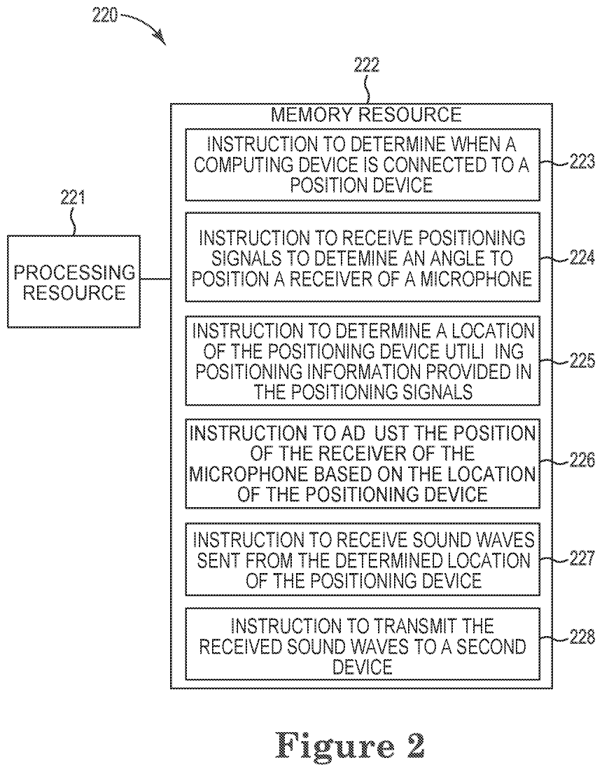

FIG. 2 illustrates an example processing resource 221 and memory resource 222 suitable with an apparatus 220. As illustrated in FIG. 2, the apparatus 220 includes a processing resource 221 and a memory resource 222. The processing resource 221 may be a hardware processing unit such as a microprocessor, application specific instruction set processor, coprocessor, network processor, application specific integrated circuit (ASIC), general purpose input output (GPIO), or similar hardware circuitry that may cause machine-readable instructions to be executed. In some examples, the processing resource 221 may be a plurality of hardware processing units that may cause machine-readable instructions to be executed. The processing resource 221 may include central processing units (CPUs) among other types of processing units. The memory resource 222 may be any type of volatile or non-volatile memory or storage, such as random-access memory (RAM), flash memory, read-only memory (ROM), storage volumes, a hard disk, or a combination thereof.

The memory resource 222 may store instructions thereon, such as instructions 223, 224, 225, 226, 227, and 228. When executed by the processing resource 221, the instructions may cause the apparatus 220 to perform specific tasks and/or functions. For example, the memory resource 222 may store instructions 223 which may be executed by the processing resource 221 to cause the apparatus 220 to determine, when a computing device is connected to a positioning device. In some examples, the computing device will connect to the positioning device responsive to the initiation of a telecommunication application on the computing device. The computing device can be communicatively coupled to a positioning device to determine the location of the positioning device in relation to the computing device. In some examples, the positioning device will determine if the computing device is connected to the positioning device prior to communication (e.g., transmitting positioning signals) with the computing device.

In some examples, when connected to the positioning device, and receiving signals from the positioning device, the processing resource of the computing device can determine the location and distance between the computing device and the positioning device. In some examples, knowing the location and the distance between the computing device and the positioning device can assist the microphone in detecting sound waves from a user in possession of the positioning device. For instance, the computer device connecting to the positioning device improves the detection of sound waves directed to the microphone, as compared to compared to computer devices with stationary microphones. That is, the positioning device notifies the computing device, via the antenna, of the location of the user in possession of the positioning device to improve the detection of the sound waves directed to the microphone. The notification can be provided by positioning signals sent from the positioning device to the computing device. As used herein, “notification” refers to the act of providing information.

The memory resource 222 may store instructions 224 which may be executed by the processing resource 221 to cause the apparatus 220 to receive positioning signals to determine an angle to position a receiver of an audio detection device. In some examples, the positioning device will send signals to the antenna of the computing device. The signals can include positioning information. That is, the signals sent by the positioning device can include information that allows the processing resource to determine the location of the positioning device. In some examples, the positioning device can send a signal to the antenna of the computing device each time the location, orientation, and/or direction changes. However, this disclosure is not so limited. For example, the positioning device can send signals to the antenna at set intervals, regardless if the location, orientation, and/or direction of the positioning device has changed. In addition, the positioning device can send signals to the antenna substantially continuously. In some examples, the processing resource will use the positioning information provided in the signal sent by the positioning device to determine the location, orientation, distance, and/or direction of the positioning device.

The memory resource 222 may store instructions 225 which may be executed by the processing resource 221 to cause the apparatus 220 to determine a location of the positioning device utilizing positioning information provided in the positioning signals. In some examples, the processing resource 221 of the computing device will calculate positioning information sent by the positioning device to determine the location, orientation, and/or direction of the positioning device. By calculating the positioning information, the processing resource 221 also determines the distance between the positioning device and the computing device. The processing resource 221 can calculate the location of the positioning device by using a variety of position calculation methods. For instance, the processing resource 221 can measure the time it takes for the signal to travel to the antenna of the computing device from the positioning device and back to the positioning device (e.g., Time-of-Flight), measure the time it takes for different signals to travel to the antenna of the computing device (TDoF), measure the angular direction of the received signal (AoA), and/or measure the angular direction of the signal as it leaves the positioning device (AoD), to name a few.

In some examples, the processing resource 221 can calculate the Time-of Arrival (ToA) to determine the location of the positioning device. For example, the processing resource 221 can use the time the signal left the positioning device, the time the signal is received by the antenna of the computing device, and the speed of the signal as it travels to determine the location of the positioning device. In addition, the processing resource 221 can calculate the Time-Difference-of Arrival (TDoA) to determine the location of the positioning device. For example, the processing resource 221 can use the speed of the signal and the time the signal arrived at the antenna of the computing device to determine the location of the positioning device.

The memory resource 222 may store instructions 226 which may be executed by the processing resource 221 to cause the apparatus 220 to adjust the position of the receiver of the microphone based on the location of the positioning device. In some examples, once the processing resource 221 determines the location of the positioning device, the processing resource 221 will cause the microphone to reposition based on the location of the positioning device. For example, the receiver of the microphone will adjust towards the direction of the positioning device. In some examples, the receiver can physically reposition to adjust towards the direction of the positioning device. Directing the receiver of the microphone towards the positioning device can improve the detection of the sound waves directed towards the microphone. That is, the microphone receiver will be able to better detect sound waves directed to the microphone from a user in possession of the positioning device when the receiver of the microphone is facing the positioning device, as compared to microphone receivers that do not adjust and are not facing the direction of the positioning device.

The receiver of the microphone will adjust each time a different location (e.g., different from the immediately previous location) is calculated. The adjustment of the microphone is based on the location of the positioning device. That is, as a user, in possession of the positioning device, moves and changes location the receiver of the microphone will adjust positions to face the user, with the positioning device, to improve the quality of the sound waves produced by the user, as compared to a microphone and/or receiver that does not adjust. In some examples, when the calculated location of the positioning device is different that a previously calculated location of the positioning device, the processing resource will position the microphone receiver in the direction of the newly calculated location.

The memory resource 222 may store instructions 227 which may be executed by the processing resource 221 to cause the apparatus 220 to receive sound waves sent from the determined location of the positioning device. The microphone can receive sound waves from a user in possession of the positioning device. In some examples, the receiver of the microphone will face the direction of the user in possession of the positioning device when the user produces sound waves. Since the receiver will be directed towards the user in possession of the positioning device, the microphone will be able to clearly detect the sound waves from the user. Further, the microphone will be able to detect better quality sound waves from a user in possession of the positioning device, as compared to microphones that are not faced towards the user producing the sound waves.

The memory resource 222 may store instructions 228 which may be executed by the processing resource 221 to cause the apparatus 220 to transmit the received sound waves to a second device. In some examples, the processing resource 221 will cause the sound waves detected by the microphone to be sent to a second computing device communicatively coupled to the computing device. For example, the processing resource 221 can send the detected sound waves to an audio sensor of the second computing device. However, this disclosure is not so limited. For example, the processing resource 221 can cause the detected sound waves to be sent to an audio sensor communicatively coupled to the computing device (e.g., first computing device) and/or an external audio sensor (e.g., a standalone audio sensor).

FIG. 3 illustrates an example of a system 300 including a computing device 302 and a positioning device 312. FIG. 3 can include analogous or similar elements as FIG. 1. For example, FIG. 3 can include a computing device 302, a microphone 304, a receiver 306, an audio sensor 310, and an antenna 308.

In some examples, the system 300 includes a computing device 302 and a positioning device 312. The positioning device 312 can be communicatively coupled to the computing device 302. The positioning device 312 sends signals to the computing device 302. For example, the positioning device sends signals including information related to orientation, mobility, location, etc. The positioning device 312 can send the signal to the computing device 302 via communication channel 311.

Channel 311 can be a wireless communication channel that connects the positioning device 312 to the computing device 302. The channel 311 can allow the positioning device 312 to send signals to the computing device 302 and receive signals from the computing device 302. Likewise, the channel 311 can allow the computing device 302 to communicate with the positioning device 312 by sending and receiving signals. However, this disclosure is not so limited. For example, channel 311 can be a wired communication channel between the computing device 302 and the positioning device 312.

In some examples, the positioning device 312 can transmit a signal, via the channel 311, to the antenna 308 to communicate with the computing device 302. For example, the positioning device 312 can transmit positioning signals to the antenna 308 of the computing device 302. The positioning signal can contain positioning information that allows the computing device 302 to position and reposition the receiver 306 of the microphone 304. For example, based on the received positioning information, the computing device 302 will adjust the receiver 306 to point the receiver 306 in the direction of the positioning device 312. That is, as the positioning device 312 changes locations the receiver 306 will adjust position to face the positioning device 312. In some examples, the receiver 306 can adjust in a range from ten (10) to fifteen (15) degree increments. For example, the receiver 306 can be adjusted 10° (degrees) 15°, 25°, 30°, 35°, 40°, 45°, 50°, 55°, 60°, etc. as needed to position the receiver 306 in the direction of the positioning device 312.

In some examples, adjusting the receiver 306 can improve the sound wave detection of the microphone 304, as compared to microphones that include receiver that do not adjust. That is, with the receiver 306 facing the positioning device 312, the microphone 304 will be able to improve the detection of the sound waves from a user in possession of the positioning device 312. The computing device 302 will send the received sound waves to an audio sensor 310. As illustrated in FIG. 3, the audio sensor 310 can be located in the computing device 302. However, this disclosure is not so limited. That is, the computing device 302 can send the sound waves to an audio sensor located on a device external to the computing device 302.

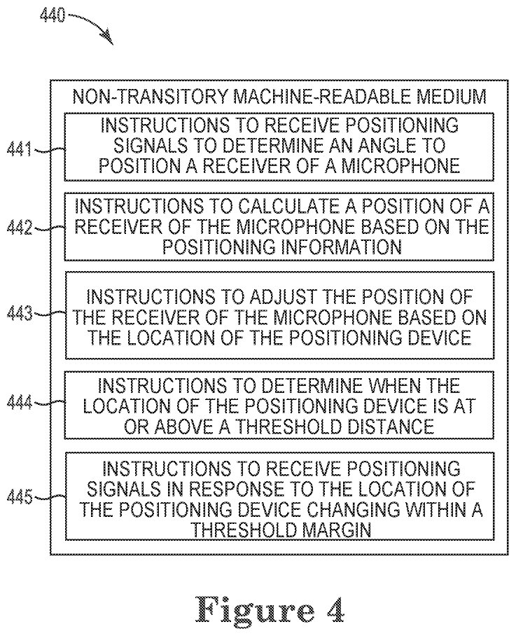

FIG. 4 illustrates an example diagram of a non-transitory machine-readable medium 440 suitable with a system. A processing resource may execute instructions stored on the non-transitory machine-readable medium 440. The non-transitory machine-readable medium 440 may be any type of volatile or non-volatile memory or storage, such as random-access memory (RAM), flash memory, read-only memory (ROM), storage volumes, a hard disk, or a combination thereof.

The non-transitory machine-readable medium 440 stores instructions 441 executable by a processing resource to receive positioning signals to determine an angle to position a receiver of the microphone. In various examples, the processing resource will execute accept instructions 441 to obtain information related to the location of a positioning device. The received signals can include positioning information that will allow the processing resource to determine the location of the positioning device. In some examples, the processing resource can determine the location of the positioning device by performing calculations using the information provided in the positioning signals.

The non-transitory machine-readable medium 440 stores instructions 442 executable by a processing resource to calculate a position of the receiver based on the positioning information. In some examples, the processing resource will execute calculate instructions 442 to determine the position of the receiver. As described herein, the processing resource uses ToF, TDoF, AoA, AoD, ToA, and/or TDoA to determine the location of the positioning device. In some examples, the receiver of the microphone will adjust positions based on the location of the positioning device as determined by the calculation made with the positioning information. The positioning information can provide the computing device with the means to determine the exact location, orientation, direction, etc. of the positioning device. Once the location, orientation, direction, etc. of the positioning device is calculated, the computing device will determine if the receiver position should be adjusted or if the receiver should remain in the current position.

The non-transitory machine-readable medium 440 stores instructions 443 executable by a processing resource to adjust the position of the receiver based on the calculated location of the positioning device. In some examples, the processing resource will execute change instructions 443 to change the position of the receiver when the calculated location of the positioning device is different from the immediately previous calculated position of the positioning device. The processing resource will adjust the receiver of the microphone to face the positioning device in order to detect quality sound waves from a user in possession of the positioning device.

In some examples, the positioning signal provided to the computing device can inform the computing device that the positioning device is actively moving as the signal is being transmitted from the positioning device. The processing resource of the computing device can use the positioning information in the signal to adjust the position of the receiver in the same direction the positioning device is moving at the same time the positioning device is moving. For example, the signal received by the computing device can inform the computing device that the positioning device is moving in a set direction at a set speed, and the processing resource can cause the receiver position to adjust in the same direction at the same speed as the positioning device based on the received signal. In some examples, the receiver position may continue to adjust until a subsequent signal is received, at which point the processing resource would make adjustments, or refrain from making adjustments, to the receiver based on the subsequent signal. However, this disclosure is not so limited. That is, in some examples, the receiver can transition with the positioning device for a set period of time and then halt the transition of the receiver until a subsequent signal is received.

The non-transitory machine-readable medium 440 stores instructions 444 executable by a processing resource to determine when the location of the positioning device is at or above a threshold distance. In some examples, the processing resource will execute detect instructions 444 to determine the distance between the positioning device and the computing device. In some examples, is the distance between the positioning device and the computing device is at or above a threshold distance, the processing resource can cause the volume of sound waves directed to the microphone to increase before transmitting the sound waves to an audio device. As used herein, the term “above a threshold” can, for example, refer to a value crossing a first side of a bound. As used herein, the term “below a threshold” can, for example, refer to a value crossing a second side of a bound. As used herein, the term “at a threshold” or “reaches a threshold level” can, for example, refer to a value being at a bound.

For example, if the positioning device is at or above a threshold distance, the sound waves from a user in possession of the positioning device may be low, as compared to when the positioning device is below the threshold distance. As such, to improve the quality of the sound waves, the processing resource can increase the volume of the sound waves. In some examples, processing resource will determine the positioning device is at or above a threshold distance and analyze the volume of the sound waves before increasing the volume of the sound waves and transmitting the sound waves to an audio device. Hence, the processing resource will adjust, by increasing or decreasing, a volume of the sound waves when the received sound waves originate from a distance at or greater than a threshold distance. Similarly, if the positioning device is below a threshold distance, the processing resource can analyze the volume of the sound waves received from a user in possession of the positioning device and increase or decrease the volume of the sound waves to produce a quality sound.

The non-transitory machine-readable medium 440 stores instructions 445 executable by a processing resource to receive positioning signals in response to the location of the positioning device changing within a threshold margin. In some examples, the processing resource will execute accept instructions 445 to obtain updated positioning information. In some examples, the processing resource can adjust the position of the receiver of the microphone when the location of the positioning device, in reference to the position of the receiver, changes at or above a threshold margin. That is, if the location of the positioning device has changed within a threshold margin in reference to the direction of the receiver position, the processing resource may refrain from adjusting the position of the receiver. However, in contrast, if the location of the positioning device is at or above a threshold margin in reference to the direction of the receiver, the processing resource may adjust the position of the receiver. That is, the processing resource will adjust the receiver of the microphone when the location of the positioning device in relation to the position/direction of the receiver is at or above a threshold margin. However, this disclosure is not so limited. For example, the processing resource can adjust the receiver of the microphone when the location of the positioning device changes within the threshold margin.

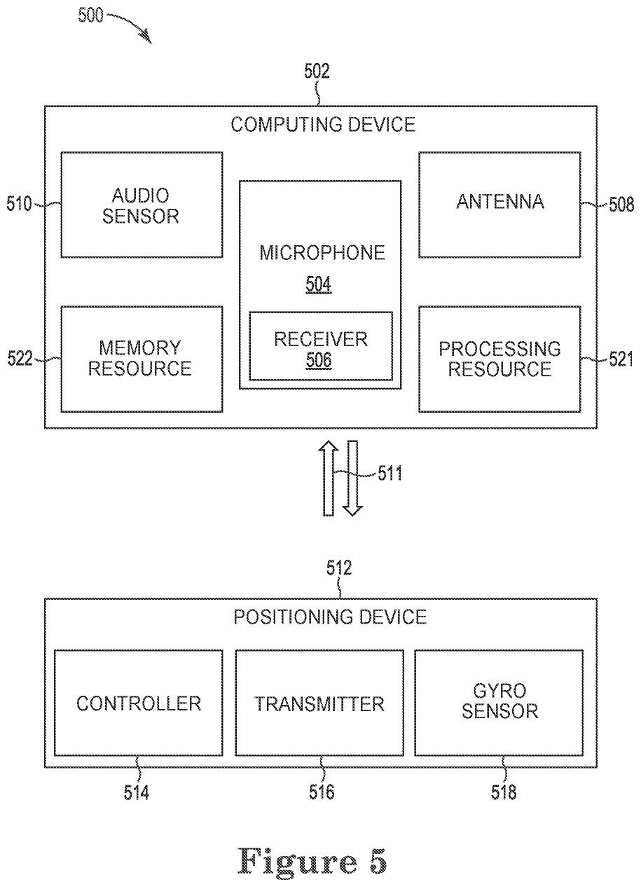

FIG. 5 illustrates an example of a system 500 including a computing device 502 and a positioning device 512. FIG. 5 can include analogous or similar elements as FIGS. 1 and 3. For example, FIG. 5 can include system 500, a computing device 502, a microphone 504, a receiver 506, an audio sensor 510, a processing resource 521, a memory resource 522, an antenna 508, a positioning device 512, and channel 511.

In some examples, the system 500 includes a computing device 502 to receive positioning signals at the antenna 508 and a processing resource 521 to cause the receiver 506 of the microphone 504 to adjust based on the received positioning signals. That is, the antenna 508 can receive signals and transmit positioning information related to the signals to the processing resource 521. The processing resource 521 can use the positioning information to cause the receiver 506 to adjust positions. In some examples, the microphone 504 will receive sound waves from and external source. That is, the sound waves will be sent by a user in possession of the positioning device 512. The sound waves will be sent from a location determined (e.g., calculated) by the processing resource 521 using the positioning information. For instance, the positioning device 512 will send positioning information to the computing device 502 for calculation and the computing device 502 will expect the sound waves to come from the location calculated by the computing device 502. As the microphone detects sound waves from a user, the processing resource can send the sound waves to an external and/or internal audio sensor 510.

In some examples, the system 500 can also include positioning device 512 communicatively coupled to the computing device 502 to send signals to the computing device 502 via channel 511. For example, the controller 514 of the positioning device 512 can cause the transmitter 516 to send different types of signals to the computing device 502. For instance, the transmitter 516 can send positioning signals used to determine the location, mobility, and/or direction of the positioning device 512. That is, the processing resource 521 of the computing device 502 can use the positioning signals to determine where the positioning device 512 is located, if the positioning device 512 is moving, and/or the direction the positioning device 512 is facing. Moreover, the transmitter 516 can send status signals that inform the computing device 502 of the orientation of the positioning device 512 and/or informs the computing device that positioning signals will be temporarily stopped based on the orientation of the positioning device 512. As used herein, the term “controller” refers to a computing device that may contain a processing resource and a memory resource to execute instructions.

In some examples, the positioning device 512 includes a gyro sensor 518 to determine the orientation of the positioning device 512. As used herein, a “gyro sensor” refers to a device used to measure and/or maintain orientation and angular velocity. The gyro sensor 518 will be able to determine if the positioning device 512 is flat on a surface or otherwise out of the possession of a user. Similarly, the gyro sensor 518 will be able to determine if the positioning device 512 is in the possession of the user. In some examples, the controller 514 will cause the transmitter 516 to send a signal notifying the computing device 502 of the orientation of the positioning device 512. For example, the transmitter 516 can send a signal notifying the computing device that the positioning device 512 is out of the possession of the user and positioning signals will be temporarily suspended. In contrast, the transmitter 516 can send a signal notifying the computing device that the positioning device 512 is in the possession of the user and positioning device 512 will resume sending positioning signals. That is, the gyro sensor 518 can detect a change in the orientation of the positioning device 512 and the transmitter 516 will send a signal notifying the computing device 502 of the changed orientation.

For example, as described herein, if the gyro sensor 518 detects the positioning device 512 is in a substantially flat orientation the transmitter 516 will refrain from sending positioning information to the computing device 502, subsequent to sending a notification (e.g., signal notifying) to the computing device 502 of the positioning device 512 orientation. Moreover, the transmitter 516 may resume sending positioning signals to the computing device 502, responsive to the gyro sensor 518 detecting the positioning device 512 has transitioned from a substantially flat orientation (e.g., in the possession of the user).

The figures herein follow a numbering convention in which the first digit corresponds to the drawing figure number and the remaining digits identify an element or component in the drawing. Similar elements or components between different figures can be identified by the use of similar digits. For example, 102 can reference element “02” in FIG. 1, and a similar element can be referenced as 302 in FIG. 3.

Elements shown in the various figures herein can be capable of being added, exchanged, and/or eliminated so as to provide a number of additional examples of the disclosure. In addition, the proportion and the relative scale of the elements provided in the figures are intended to illustrate the examples of the disclosure and should not be taken in a limiting sense.

The above specification and examples provide a description of the method and applications and use of the system and method of the present disclosure. Since many examples can be made without departing from the scope of the system and method, this specification merely sets forth some of the many possible example configurations and implementations.

It should be understood that the descriptions of various examples may not be drawn to scale and thus, the descriptions can have a different size and/or configuration other than as shown therein.

What is claimed:

1. A computing device comprising:
a microphone;
an antenna to receive signals providing positioning information; and
a non-transitory machine-readable medium storing instructions executable by a processing resource to:
receive positioning information from the antenna;
calculate a position of a receiver of the microphone based on the positioning information; and
adjust the position of the receiver of the microphone towards a direction determined by the calculated positioning information.

2. The computing device of claim 1, further comprising instructions to:
receive sound waves from an external source based on the adjusted position of the receiver of the microphone; and
transmit the sound waves to an audio sensor.

3. The computing device of claim 2, further comprising instructions to adjust, by increasing or decreasing, a volume of the sound waves when the received sound waves originate from a distance at or greater than a threshold distance.

4. The computing device of claim 2, wherein the audio sensor is located in a device external to the computing device.

5. The computing device of claim 2, wherein the audio sensor is located on the computing device.

6. The computing device of claim 1, wherein the position of the receiver is adjusted in fifteen (15) degree increments.

7. A non-transitory machine-readable medium storing instructions executable by a processing resource to:
determine when a computing device is connected to a positioning device;
receive positioning signals to determine an angle to position a receiver of a microphone;
determine a location of the positioning device utilizing positioning information provided in the positioning signals;
adjust the position of the receiver of the microphone based on the location of the positioning device;
receive sound waves sent from the determined location of the positioning device; and
transmit the received sound waves to a second device.

8. The medium of claim 7, further comprising instructions to determine when the location of the positioning device is at or above a threshold distance.

9. The medium of claim 7, further comprising instructions to connect to the positioning device responsive to the computing device activating an application on the computing device.

10. The medium of claim 7, further comprising instructions to receive positioning signals in response to the location of the positioning device changing within a threshold margin.

11. A system comprising:
a computing device, communicatively coupled to a positioning device, comprising:
a microphone including a receiver to receive sound waves;
an antenna to receive a signal and transmit positioning information related to the received signal to a processing resource; and
a non-transitory machine-readable medium storing instructions executable by the processing resource to:
calculate a location of the positioning device utilizing positioning information;
determine if the calculated location of the positioning device is different from a previously calculated location of the positioning device;
position the receiver in a direction towards the calculated location, responsive to the determination that the calculated location is different from the previously calculated location; and
receive sound waves from an external source transmitted from the calculated location; and
the positioning device comprising:
a controller to:
determine an orientation of the positioning device; and
cause a transmitter to send positioning information, via the signal, to the antenna of the computing device based on the determined orientation of the positioning device.

12. The system of claim 11, further comprising the controller to determine when the positioning device is connected to the computing device prior to causing the transmitter to send positioning information to the antenna of the computing device.

13. The system of claim 11, further comprising the controller to:
detect a change in the orientation of the positioning device; and
send a notification to the computing device based on the changed orientation.

14. The system of claim 13, further comprising the controller to:
detect the positioning device in a substantially flat orientation; and
refrain from sending positioning information to the computing device, subsequent to sending the notification to the computing device.

15. The system of claim 14, further comprising the controller to resume sending positioning information to the computing device, responsive to detecting the positioning device transition from the substantially flat orientation.
